(19) United States
(12) Patent Application Publication
(10) Pub. No.: US 2010/0097360 A1
(43) Pub. Date: Apr. 22, 2010

(54) DISPLAY DRIVING APPARATUS

(76) Inventors: Gyu-Hyeong Cho, Daejeon (KR); Yong-Joon Jeon, Daejeon (KR); Jin-Yong Jeon, Daegu (KR); Seung-Chul Jung, Gwangju (KR); Ki-Duk Kim, Ulsan (KR); Sung-Woo Lee, Gyeongsangnam-do (KR)

Correspondence Address: The Belles Group, P.C., 1518 Walnut Street, Suite 1706, Philadephia, PA, 19102, US

(21) Appl. No.: 12/578,046

(22) Filed: Oct. 13, 2009

(30) Foreign Application Priority Data
Oct. 16, 2008 (KR) 10-2008-0101424

(51) Int. Cl. G09G 5/00

(52) U.S. Cl. 345/205

(57) ABSTRACT

Disclosed is a display driving apparatus. The display driving apparatus comprises: a current DAC generating a data current; a data line connected to a pixel circuit requiring data writing on a matrix array of a display panel; an adjacent data line located adjacent to the data line; a current mirror feedbacking an excessive charging current generating due to parasitic capacitance of the adjacent data line as a charging current for charging parasitic capacitance of the data line; a current output unit connected to the current mirror and including a first driving transistor unit for driving the data line, and a second driving transistor unit for driving the adjacent data line; a source follower driving the current output unit according to an output node voltage of the current DAC; and a first constant current source discharging parasitic capacitance excessively charged in the data line and the adjacent data line.

### CROSS-REFERENCE TO RELATED APPLICATION

This application claims priority to Korean Patent Application No. 10-2008-0101424, filed Oct. 16, 2008, the entirety of which is hereby incorporated by reference.

### BACKGROUND OF THE INVENTION

1. Field of the Invention

The present invention relates to a display driving apparatus.

2. Description of the Related Art

A current mode driving method may prevent spatial non-uniformity and time characteristic change of a thin film transistor forming a backplane of an active-matrix organic light-emitting diode (AMOLED) panel and enable an exact data current to flow to an OLED.

However, the current mode driving method has a disadvantage in that the driving time is too long due to large parasitic capacitance existing in a data line and a transistor of the AMOLED panel. There have been proposed various methods to improve a driving speed while maintaining driving precision of a data current as in the current mode driving method.

FIG. 1 to FIG. 3 are circuitry diagrams illustrating the prior art conventional current mode driving type display driving apparatus using feedback.

Referring to FIG. 1, an electric current flowing through an OLED in the display driving apparatus is determined as Vin/R_{F}. A differential amplifier automatically sets a gate voltage V_{G} of a driving transistor T1 such that the electric current flows through the driving transistor T1 serially connected to a resistor R_{F}. That is, in the display driving apparatus shown in FIG. 1, a data current is transferred to the driving transistor T1 of a pixel circuit 100 regardless of the characteristics of the driving transistor T1. One important characteristic of the driving transistor T1 is the electric current flowing through an OLED, which can be determined by calculating Vin/R_{F}. In a step of programming a data current flowing through the pixel circuit 100, a signal applied to a select line is enabled to make all signal paths a connected state.

However, because an electric current less than or equal to 1 uA is determined through a resistor R_{F}, there is a need for a very large resistance value. In a general TFT Backplane process, resistance may be implemented by controlling a doping concentration and a geometrical form of a polycrystalline silicon. However, the resistance achieved by such a method has a difficulty in obtaining matching characteristics due to properties of process and materials. Further, the larger the resistance is, the more difficult it is to secure the matching characteristics. In particular, when implementing a resistor for every pixel circuit in a driving apparatus shown in FIG. 1, resistance has a very large range.

In a driving apparatus shown in FIG. 2, a resistor R_{F} present in every pixel circuit is moved to a driving circuit side. In this way, the pixel circuits are simplified because pixel circuits positioned on a data line share the resistor R_{F}.

However, because the driving apparatus shown in FIG. 2 uses resistance larger than 1 Mohm, a driving circuit chip has a resistor with a large area. The larger the resistance, the more likely a problem will arise when inter-resistor matching of a data line. Furthermore, properties of a feedback loop applied in the driving apparatuses shown in FIG. 1 to FIG. 3 can change according to a data current. Accordingly, there is a need for a method of securing loop stability with respect to a total data current range.

FIG. 4 is a circuit diagram illustrating a parasitic capacitance charging/discharging current compensation type display driver of a conventional prior art AMOLED display driving apparatus.

The display driver 400 shown in FIG. 4 conceptually indicates a parasitic capacitance charging/discharging current compensation type. The display driver 400 senses a voltage variation occurring due to charging/discharging of parasitic capacitance C_{P} existing in a data line, and adjusts a voltage controlled current source (VCCS) 405 by an output voltage of an integrator 403, thereby offsetting the influence of the parasitic capacitance C_{P.} As a result, the influence of the parasitic capacitance C_{P} may be reduced and the data current driving speed can be improved.

FIG. 5 is a circuit diagram illustrating a conventional prior art display driving apparatus embodied by a driving concept of the display driver shown in FIG. 4.

Referring to FIG. 5, in the display driving apparatus, a capacitor C_{PC} has capacitance similar to parasitic capacitance C_{PP} of a data line and is connected to an input node X. An electric current generated for charging/discharging the capacitor C_{PC}, is copied and charged/discharged with the parasitic capacitance C_{PP}, thereby improving driving speed reduction due to C_{PP}.

However, capacitance of the capacitor C_{PC} connected to the input node X is a large value, which is almost the same as the parasitic capacitance C_{PP}. When integrating the capacitor C_{PC} on an AMOLED display driving chip, it takes up a significant area of the chip. Moreover, since the parasitic capacitance C_{PP} present in the data line changes according to a panel or a location of the panel, it is substantially difficult to design a driving chip considering a deviation of the parasitic capacitance C_{PP} in the capacitor C_{PC}.

In addition, in the display driving apparatus shown in FIG. 5, because a capacitor C_{PC} having capacitance identical or similar to the parasitic capacitance C_{PP} is connected to an input node X forming a high impedance node of a positive loop and a negative loop, it greatly reduces a frequency band width of the two feedback loops, which leads to a significant reduction at operation speed.

FIG. 6 is a circuit diagram illustrating a conventional prior art parasitic capacitance charging/discharging current compensation type driving apparatus of an AMOLED display.

The driving apparatus shown in FIG. 6 includes two outputs B1 and B2. The output B1 is connected to a pixel circuit to be driven through a data line DL of an AMOLED panel. The output B2 is connected to an adjacent data line ADL that the pixel circuit does not select, and provides parasitic components with parasitic capacitance C_{DP} of the data line DL. Assuming that the same parasitic capacitance C_{DP} is present in the data line DL and the adjacent data line ADL, an electric current generated for charging/discharging the parasitic capacitance C_{DP} of the adjacent data line ADL through the output B2 is copied by a transistor M3 and a transistor M4 constituting a current mirror. Consequently, a data current I_{DATA} is rapidly transferred to a pixel circuit without current loss.

Since the driving apparatus shown in FIG. 6 generates an electric current charging/discharging the parasitic capacitance C_{DP}of the adjacent data line ADL, it is not necessary to mount a capacitor C_{PC} therein having capacitance identical or similar to the parasitic capacitance C_{PP} present in a data line in a driving chip as is required in the conventional method of FIG. 5.

However, the driving apparatuses shown in FIG. 5 and FIG. 6 use an operation transconductance amplifier (OTA) for obtaining a desired loop gain. This causes the requirement of an additional area and power consumption for embodying the OTA.

Furthermore, because an output impedance of the OTA is large, a low frequency pole is formed by the output impedance of the OTA, namely, gate capacitance of a first transistor M1 and a second transistor M2, thereby resulting in operation instability. In order to prevent this, an additional frequency compensation circuit is required.

Moreover, since the driving apparatuses shown in FIG. 5 and FIG. 6 use a constant current source IB, the performance is restricted according to the size of the constant current source IB in a charging or discharging procedure of the parasitic capacitances C_{Pc}, C_{DP} present in the data line. In the driving apparatus shown in FIG. 5, a second transistor M2 and a fourth transistor M4 constitutes a dynamic current source to discharge excessively charged parasitic capacitance C_{PP} of a data line. However, when a charge quantity charged in a capacitor C_{PP} is small, because the constant current source IB charges the capacitor C_{PP}, a charge time is determined by the size of the constant current source IB.

Accordingly, to rapidly move a voltage of a data line by a gate voltage of a pixel circuit determined by a data current through charging/discharging of the capacitor C_{PP}, because the size of the constant current source IB should be increased, power consumption of a total driving circuit is increased.

In the driving apparatus shown in FIG. 6, a third transistor M3 and a fourth transistor M4 constituting a dynamic current source may efficiently charge the parasitic capacitance C_{DP} of a data line. Meanwhile, upon excessively charging a capacitor C_{DP}, the constant current source IB discharges the capacitor C_{DP}. Consequently, to charge/discharge the capacitor C_{DP}, the size of the constant current source IB should be increased. This also leads to an increase in power consumption of the driving apparatus.

### SUMMARY OF THE INVENTION

The present invention has been made in view of the above problems, and it is an object of the present invention to provide a display driving apparatus that minimizes the chip area and the driving delay, and removes under-damping occurring during driving a high data current.

In accordance with an exemplary embodiment of the present invention, there is provided a display driving apparatus comprising: a current digital/analog converter generating a data current corresponding to an input digital data; a data line connected to a pixel circuit requiring data writing on a matrix array of display panel; an adjacent data line located adjacent to the data line; a current mirror feedbacking an excessive charging current generating due to parasitic capacitance of the adjacent data line as a charging current for charging parasitic capacitance of the data line; a current output unit connected to the current mirror and comprising a first driving transistor unit for driving the data line, and a second driving transistor unit for driving the adjacent data line; a source follower driving the current output unit according to an output node voltage of the current digital/analog converter; and a first constant current source discharging parasitic capacitance excessively charged in the data line and the adjacent data line.

Preferably, the current mirror has a stack mirror structure.

More preferably, the first driving MOS transistor unit includes a plurality of cascade-connected MOS transistors, the second driving MOS transistor unit comprises a plurality of cascade-connected MOS transistors, the source follower comprises a third MOS transistor unit having a plurality of cascade-connected MOS transistors and a second constant current source connected to the third MOS transistor unit, gates of the MOS transistors of the third MOS transistor unit are connected to an output node of the current digital/analog converter, and sources of the MOS transistors of the third MOS transistor unit are connected to gates of MOS transistors of the first driving MOS transistor unit and the second driving MOS transistor unit.

In accordance with a second embodiment of the present invention, there is provided a display driving apparatus comprising: a current digital/analog converter generating a data current corresponding to an input digital data; a data line connected to a pixel circuit requiring data writing on a matrix array of a display panel; an adjacent data line located adjacent to the data line; a current mirror feedbacking an excessive charging current generating due to parasitic capacitance of the adjacent data line as a charging current for charging parasitic capacitance of the data line; a current output unit connected to the current mirror and including a first driving MOS transistor for driving the data line, and a second driving MOS transistor for driving the adjacent data line; a first differential amplifier including a non-inverting input terminal connected to an output node of the current digital/analog converter, an inverting input terminal connected to a first reference voltage, and an output terminal connected to gates of the first driving MOS transistor and second driving MOS transistor; a constant current source for discharging parasitic capacitance excessively charged in the data line and the adjacent data line; a dynamic current source for supporting the constant current source; and a sink current control unit comprising a current sensor sensing an electric current having a constant ratio to a charging current flowing from the current mirror, and a second differential amplifier comparing a voltage corresponding to the electric current sensed by the current sensor with a second reference voltage, and operating the dynamic current source when the corresponding voltage is less than the second reference voltage.

Preferably, the dynamic current source includes a MOS transistor.

More preferably, the current sensor comprises: a first MOS transistor having a predetermined mirror ratio to the current mirror and including a source receiving an electric current with a predetermined ratio to the charging current; a second MOS transistor including a drain connected to a drain of the first MOS transistor; a passive resistor element and a capacitor serially connected to each other between a source and a drain of the second MOS transistor, a connecting node between the passive resistor element and the capacitor is connected to a gate of the second MOS transistor, and the second differential amplifier includes an inverting input terminal connected to a connecting node between the first MOS transistor and the second MOS transistor, and a non-inverting input terminal connected to a second reference voltage, and an output terminal connected with the dynamic current source.

In accordance with a third embodiment of the present invention, there is provided a display driving apparatus comprising: a current digital/analog converter generating a data current corresponding to an input of digital data; a data line located on a matrix array of the display panel to be connected to a pixel circuit requiring data writing; an adjacent data line located adjacent to the data line; a current mirror feedbacking an excessive charging current generating due to parasitic capacitance of the adjacent data line as a charging current for charging parasitic capacitance of the data line; a current output unit connected to the current mirror and including a first driving MOS transistor for driving the data line, and a second driving MOS transistor for driving the adjacent data line; a first differential amplifier including a non-inverting input terminal connected to an output node of the current digital/analog converter, an inverting input terminal connected to a first reference voltage, and an output terminal connected to gates of the first driving MOS transistor and the second driving MOS transistor; a constant current source for discharging parasitic capacitance excessively charged in the data line and the adjacent data line; a dynamic current source for supporting the constant current source; a sink current control unit comprising a current sensor sensing an electric current having a constant ratio to a charging current flowing from the current mirror, and a second differential amplifier comparing a voltage corresponding to the electric current sensed by the current sensor with a second reference voltage, operating the dynamic current source when the corresponding voltage is less than the second reference voltage; and a loop gain control unit forming a negative feedback loop to weaken a loop gain of the current mirror.

Preferably, the dynamic current source includes a MOS transistor.

More preferably, the current sensor comprises: a first MOS transistor having a predetermined mirror ratio to the current mirror and including a source receiving an electric current with a predetermined ratio to the charging current; a second MOS transistor comprising a drain connected to a drain of the first MOS transistor; a passive resistor element and a capacitor serially connected to each other between a source and a drain of the second MOS transistor, a connecting node between the passive resistor element and the capacitor is connected to a gate of the second MOS transistor, and the second differential amplifier includes an inverting input terminal connected to a connecting node between the first MOS transistor and the second MOS transistor, and a non-inverting input terminal connected to a second reference voltage, and an output terminal connected with the dynamic current source.

Most preferably, the loop gain control unit comprises a third MOS transistor having a predetermined mirror ratio to the current mirror, and a fourth MOS transistor connected to the third MOS transistor and the adjacent data line, the negative feedback loop is formed when the fourth MOS transistor is turned-on.

In the display driving apparatus in accordance with the present invention, power consumption, a chip area, and a driving delay may be minimized, and under-damping occurring during driving a high data current may be removed.

### BRIEF DESCRIPTION OF THE DRAWINGS

The objects, features and advantages of the present invention will be more apparent from the following detailed description in conjunction with the accompanying drawings, in which:

FIG. 1 to FIG. 3 are circuitry diagrams illustrating prior art conventional current mode driving type display driving apparatuses using feedback;

FIG. 4 is a circuitry diagram illustrating a parasitic capacitance charging/discharging current compensation type display driver of a prior art conventional AMOLED display driving apparatus;

FIG. 5 is a circuitry diagram illustrating a prior art conventional display driving apparatus embodied by the driving concept of the display driver shown in FIG. 4;

FIG. 6 is a circuitry diagram illustrating a prior art conventional parasitic capacitance charging/discharging current compensation type driving apparatus of an AMOLED display;

FIG. 7 is a circuitry diagram illustrating a display driving apparatus in accordance with a first embodiment of the present invention;

FIG. 8 and FIG. 9 are circuitry diagrams illustrating a display driving apparatus in accordance with a second embodiment of the present invention;

FIG. 10 is a graph illustrating a simulation result of the display driving apparatus in accordance with a second embodiment of the present invention;

FIG. 11 illustrates the concept of a loop gain control in accordance with the present invention;

FIG. 12 to FIG. 14 are circuitry diagrams illustrating display driving apparatuses in accordance with a third embodiment of the present invention to which the concept of a loop gain control is applied;

FIG. 15 is a graph illustrating a simulation result of the display driving apparatus to which a loop gain control function is applied in accordance with the third embodiment of the present invention;

FIG. 16 is a circuitry diagram illustrating a conceptual construction of the present invention and an operation timing diagram when a display driving apparatus of the present invention is applied to an AMOLED display.

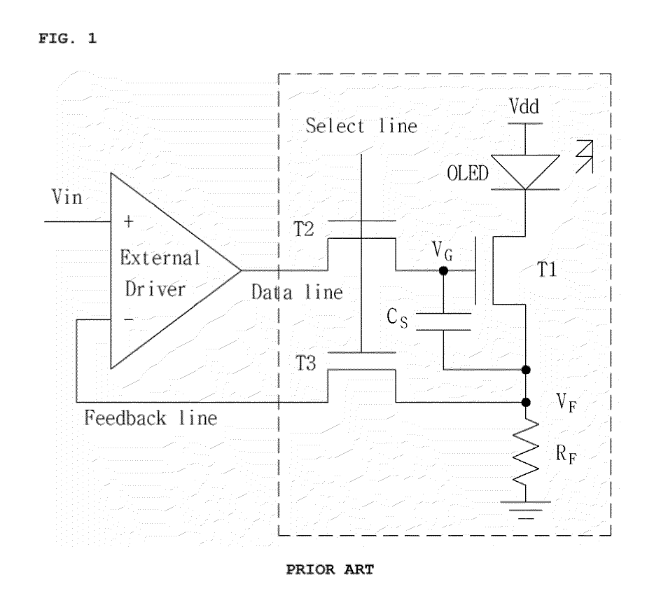

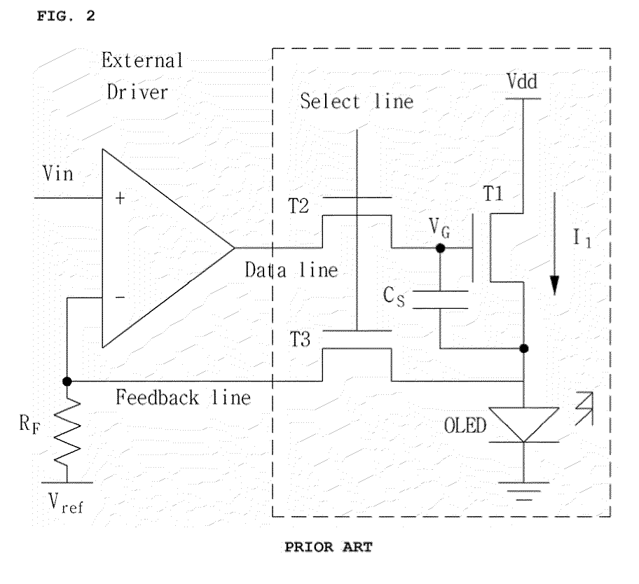

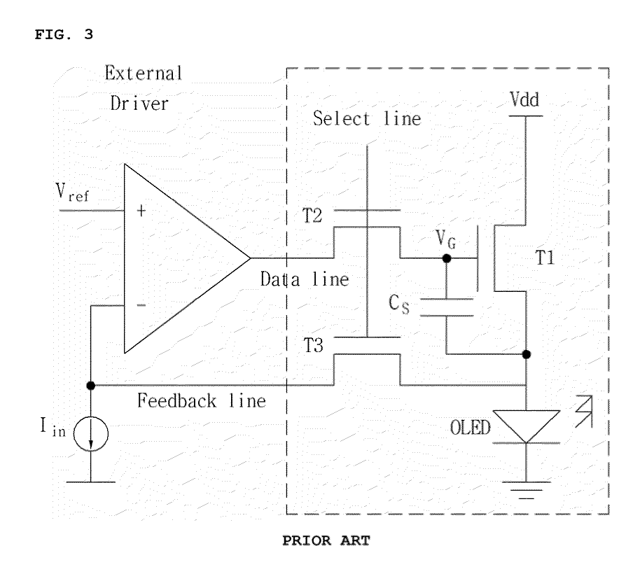

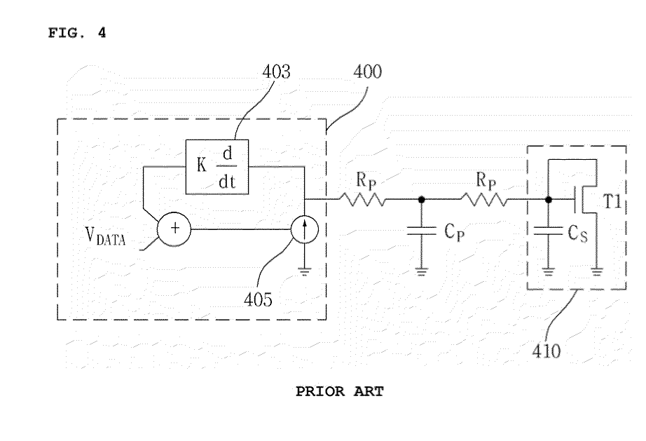

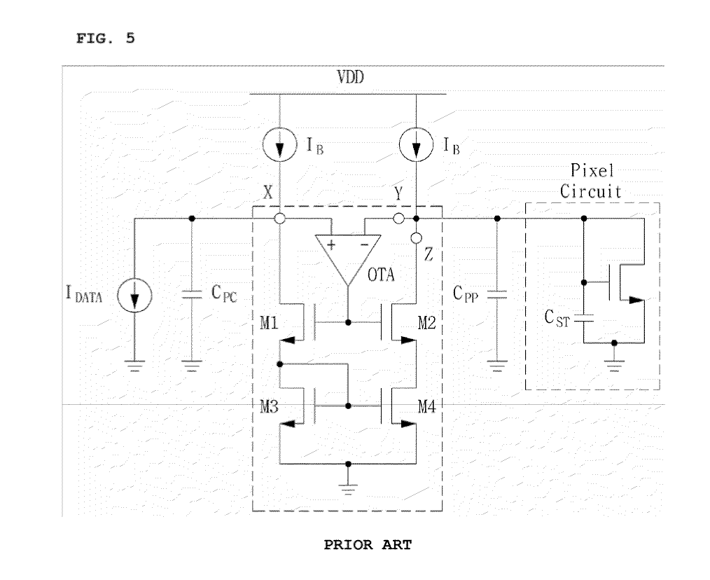

### DETAILED DESCRIPTION OF EXEMPLARY EMBODIMENTS

Hereinafter, exemplary embodiments of the present invention are described in detail with reference to the accompanying drawings.

### First Embodiment

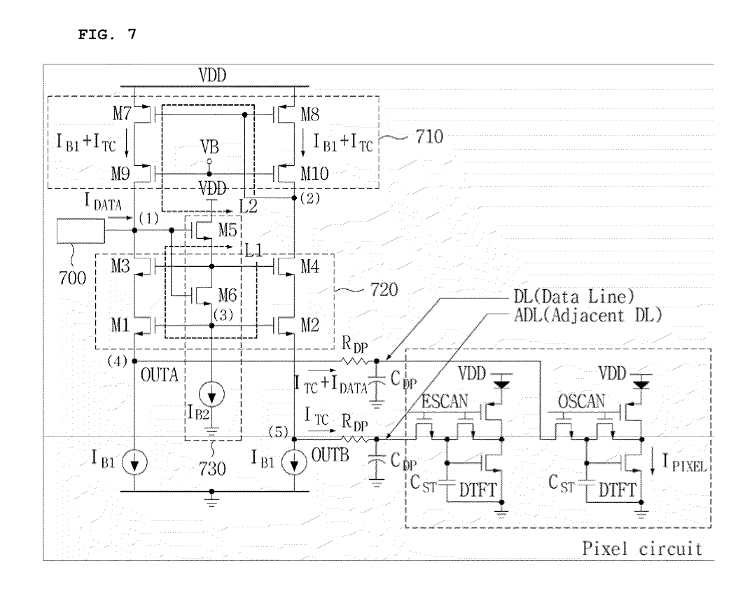

FIG. 7 is a circuitry diagram illustrating a display driving apparatus in accordance with a first embodiment of the present invention.

Referring to FIG. 7, the display driving apparatus in accordance with the first embodiment of the present invention includes a current digital/analog converter (DAC) 700, a data line DL, an adjacent data line ADL, a current mirror 710, a current output unit 720, a source follower 730, and a constant current source I_{B1.}

The current DAC 700 generates a data current corresponding to the input of digital data.

The data line DL is connected to a pixel circuit requiring data writing located on a matrix array of a display panel.

The adjacent data line ADL is located adjacent to the data line DL. The adjacent data line ADL has the same parasitic capacitance C_{DP} as that of the data line DL.

The current mirror 710 may have a stack mirror structure. The current mirror 710 may feedback an excessive charging current I_{TC} generating due to parasitic capacitance of the adjacent data line ADL using current mirroring as a charging current I_{TC} for charging parasitic capacitance C_{DP} of the data line DL.

The current output unit 720 is connected to the current mirror 710. The current output unit 720 includes a first driving transistor unit M1 and M3 for driving the data line DL, and a second driving transistor unit M2 and M4 for driving the adjacent data line ADL.

The first driving transistor unit M1 and M3 may include cascade-connected MOS transistors.

The second driving transistor unit M2 and M4 may also include cascade-connected MOS transistors.

The first driving transistor unit M1 and M3, and the second driving transistor unit M2 and M4 can be implemented by a two-stacked cascade arrangement.

The source follower 730 includes a third MOS transistor unit M5 and M6, and a second constant current source I_{B2}, which are connected between a supply voltage VDD and a ground.

The third MOS transistor unit M5 and M6 includes cascade-connected MOS transistors, and functions as a voltage follower having a gain of 1. Gates of MOS transistors in the third MOS transistor unit M5 and M6 are connected to an output node (1) of the current DAC 700. Sources of MOS transistors in the third MOS transistor unit M5 and M6 are connected to gates of the first driving transistors M1 and M3 and gates of the second driving transistor unit M2 and M4. A source of the MOS transistor M6 is also connected to the second constant current source I_{B2}.

When a data current I_{DATA} is input from the current DAC 700 during data writing, a voltage level of the output node (1) is increased, so that the third MOS transistor M5 and M6 of the source follower 730 electrically conduct to drive the MOS transistors M1, M2, M3, and M4. The data current I_{DATA} input through the output node (1) and the charging current I_{TC} output from the current mirror 710 flow to a data line DL through the MOS transistors M1 and M3 of the current output unit 720, so that parasitic capacitance C_{DP} present in the data line is charged, and the data current I_{DATA} is transferred to a pixel circuit as it is. Accordingly, a pixel current I_{PIXEL} identical to the data current I_{DATA} flows through the pixel circuit.

The first constant current source I_{B1} may be configured by two constant current sources. The two constant current sources are respectively connected to the data line DL and the adjacent data line ADL, and can function as a discharge current source for discharging the parasitic capacitance C_{DP} excessively charged in the data line DL and the adjacent data line ADL.

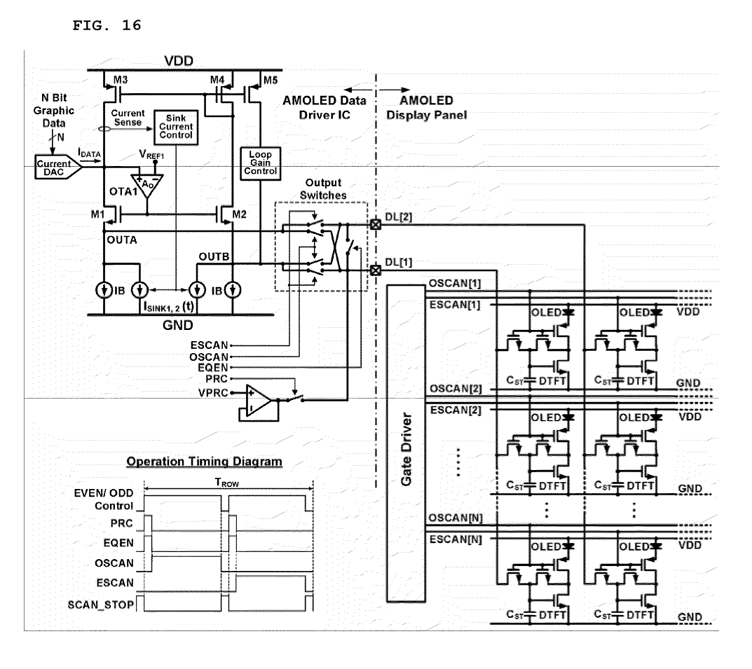

Hereinafter, an initial driving state and a total driving method of the display driving apparatus in accordance with a first embodiment of the present invention will be described with reference to FIG. 16.

FIG. 16 illustrates a conceptual construction of the present invention and an operation timing diagram when a display driving apparatus of the present invention is applied to an AMOLED display.

An AMOLED data driver IC is identical with a driving apparatus of a third embodiment to be described below. A fundamental driving method of the AMOLED data driver IC is identical with that of the driving apparatus of the first embodiment shown in FIG. 7.

Referring to FIG. 16, two output nodes OUTA and OUTB of the driving apparatus are connected to two data lines DL[1] and DL[2] through two output switches, respectively.

In this case, the data lines DL[1] and DL[2] correspond to the adjacent data line ADL and the data line DL shown in FIG. 7, respectively.

An initial driving state of the display driving apparatus will first be explained with reference to the operation timing diagram shown in FIG. 16.

In order to equalize initial driving values of the data lines DL[1] and DL[2], an equalization signal EQEN that turns on the switches connected between the data lines is enabled. At the same time, precharging can be performed to set an initial voltage of the data line DL[2] to a desired value. A PRC is the signal that performs this operation and a VPRC represents a precharging voltage.

The following is a description of a total driving method of the display driving apparatus.

First, upon enabling an OSCAN signal of a pixel circuit, the output node OUTA is connected to the data line DL[2], and the driving apparatus drives pixel circuits on an odd-numbered data line DL[2] corresponding thereto. An output node OUTB is connected to the adjacent data line DL[1]. In this case, because an ESCAN signal of a pixel circuit connected to the adjacent data line DL[1] is disabled, an even-numbered data line DL[1] is used to generate an excessive current.

Next, when an ESCAN signal of the pixel circuit is enabled, the output node OUTB is connected to the adjacent data line DL[1], and the driving apparatus drives pixel circuits on an even-numbered data line DL[1] corresponding thereto. In this case, because an OSCAN signal is disabled, an odd-numbered data line DL[2] is used to generate an excessive current.

A gate driver sequentially selects corresponding rows of the pixel circuit from a first row to a last row according to respective signals shown in the operation timing diagram of FIG. 16. Output switches select even-numbered and odd-numbered data lines included in the adjacent data line ADL so that the selected data lines maybe sequentially written into the pixel circuits.

Hereinafter, a parasitic capacitance charging/discharging current driving method of the display driving apparatus in accordance with a first embodiment of the present invention will be described with reference to FIG. 7.

First, when driving starts, an output node (4) is connected to the data line DL to be driven and the OSCAN signal is enabled, such that the output node (4) is connected to the pixel circuit. At this time, an output node (5) is connected to the adjacent data line ADL. However, because the ESCAN signal of the pixel circuit is disabled, the adjacent data line ADL is used to generate an excessive current. Accordingly, an excessive charging current I_{TC} for charging parasitic capacitance is output to the output node (5) to start charging parasitic capacitance of the adjacent data line ADL. At this time, because a voltage of the output node (5) drops, generation of the excessive charging current I_{TC} is achieved. The generation of the excessive charging current I_{TC} is more actively performed by MOS transistors M5 and M6 of a source follower 730, MOS transistors M2 and M4 of a current output unit 720, and a positive feedback loop L2 formed through a current mirror 710.

The excessive charging current I_{TC} is copied through the current mirror 710, and is output to the data line DL with the data current I_{DATA} through the first driving MOS transistors M1 and M3 of the current output unit 720, and an output node (4). Accordingly, the excessive charging current I_{TC} charges parasitic capacitance of the data line DL, and the data current I_{DATA} may be exactly and rapidly transferred to the pixel circuit without loss due to parasitic capacitance.

A negative feedback loop L1 is formed through MOS transistors M5 and M6 of the source follower 730, and MOS transistors M1 and M3 of the current output unit 720. Further, the negative feedback loop L1 stops the output node (5) from generating the excessive charging current I_{TC} and transfers only the data current I_{DATA} to the pixel circuit.

A first constant current source I_{B1} discharges excessively charged parasitic capacitance C_{DP} of data line DL and adjacent data line ADL in a state where the data line DL is connected to the output node (4) and the adjacent data line ADL is connected to the output node (5).

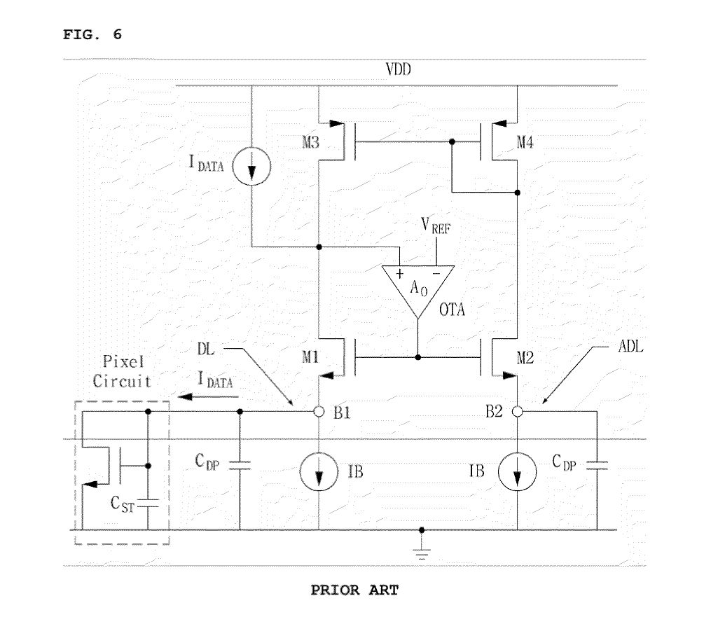

In a first embodiment of the present invention, since a source follower functioning as a voltage follower having a gain of 1 is used, it is advantageous by reducing the real implementation area and power consumption in comparison with an OTA of a conventional display driving apparatus shown in FIG. 6.

Furthermore, because the OTA of a conventional driving apparatus has large output impedance, a low frequency pole is formed by an output impedance of the OTA and gate capacitances of driving transistors, thereby allowing the occurrence of operation instability. To prevent this, an additional frequency compensation circuit is needed. However, in the first embodiment of the present invention, because the source of the MOS transistor M6 of the source follower 730 is connected with gates of MOS transistors M1 and M2 of the current output unit 720, a high frequency pole is formed at a frequency domain higher than an operation frequency band. Accordingly, the present invention does not require additional frequency compensation and is advantageous by reducing the required implementation area.

### Second Embodiment

Hereinafter, a display driving apparatus in accordance with a second exemplary embodiment of the present invention will be explained with reference to the accompanying drawings.

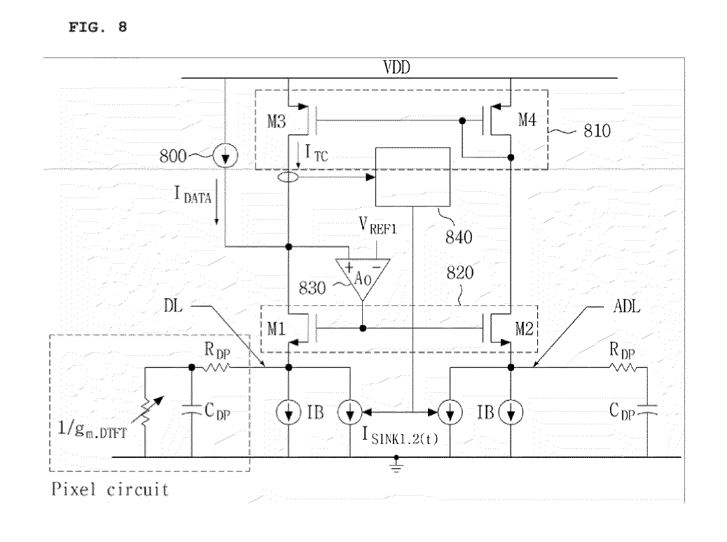

FIG. 8 is a circuitry diagram illustrating a display driving apparatus in accordance with a second embodiment of the present invention.

Referring to FIG. 8, the display driving apparatus in accordance with a second embodiment of the present invention includes a current DAC 800, a data line DL, an adjacent data line ADL, a current mirror 810, a current output unit 820, a first differential amplifier 830, a constant current source IB, dynamic current sources I_{SINK1} and I_{SINK2}, and a sink current control unit 840.

The current DAC 800 generates a data current corresponding to an input of digital data.

The data line DL is connected to a pixel circuit requiring data writing on a matrix array of a display panel.

The adjacent data line ADL is located adjacent to the data line DL. The adjacent data line ADL has the same parasitic capacitance C_{DP} as that of the data line DL.

An initial driving state and a total driving method of the display driving apparatus in accordance with the second embodiment of the present invention are respectively identical with those of the display driving apparatus in accordance with the first embodiment of the present invention. Accordingly, the description provided above with respect to the initial driving state and the total driving method of the display driving apparatus of the first embodiment of the present invention serves as a sufficient description of the initial driving state and the total driving method of the display driving apparatus in accordance with the second embodiment of the present invention. Therefore, a further description of the initial driving state and the total driving method of the display driving apparatus will not be provided and the description provided above is to be substituted herein.

The current mirror 810 feedbacks an excessive charging current I_{TC} generating due to parasitic capacitance of the adjacent data line ADL as a charging current I_{TC}.

Since operation of the current mirror 810 is identical with that of the current mirror 710 of the first embodiment, the operation of the current mirror 710 is substituted for the operation of the current mirror 810.

The current output unit 820 includes a first driving MOS transistor M1 and a second driving MOS transistor M2, which are respectively connected to the current mirror 810.

The first driving MOS transistor M1 may drive the data line DL according to an output signal of the first differential amplifier 830. The second driving MOS transistor M2 may drive the adjacent data line ADL according to an output signal of the first differential amplifier 830.

A non-inverting input terminal (+) of the first differential amplifier 830 can be connected to an output node of the current DAC 800. An inverting input terminal (−) of the first differential amplifier 830 can be connected to a first reference voltage V_{REF1}. An output terminal of the first differential amplifier 830 may be connected to gates of the driving MOS transistors M1 and M2 of the current output unit 820. The first differential amplifier 830 controls gate voltages of the driving MOS transistors M1 and M2 to maintain an output node voltage of the current DAC 800 with the first reference voltage V_{REF1}. The first differential amplifier 830 rapidly transfers a data current I_{DATA} of the current DAC 800 to the data line DL through the first driving MOS transistor M1.

The first constant current source IB may be configured by two constant current sources. The two constant current sources are respectively connected to the data line DL and the adjacent data line ADL, and can function as a discharge current source for discharging the parasitic capacitance C_{DP}excessively charged in the data line DL and the adjacent data line ADL.

A disadvantage of the conventional display driving apparatus shown in FIG. 6 is that a current value of the constant current source IB is too small. The current value of the constant current source IB should be significantly increased to rapidly discharge excessively charged parasitic capacitance C_{DP} because a function discharging parasitic capacitance C_{DP} depends on the constant current source IB.

Accordingly, since there is a large parasitic capacitance in a large middle AMOLED panel, a required value of the constant current source IB is significantly increased, thereby increasing the entire power consumption of the driving circuit. Further, while the constant current source IB discharges excessively charged parasitic capacitance C_{DP}, a bias current flowing through MOS transistors M1 and M2 of the current output unit 820 is reduced. In this state, when a data current less than several tens μA is driven, a driving delay can occur.

Accordingly, in order to compensate the disadvantage of the conventional display driving apparatus shown in FIG. 6, the display driving apparatus of the present invention includes dynamic current sources I_{SINK1} and I_{SINK2} and a sink current control unit 840. The dynamic current sources I_{SINK1} and I_{SINK2} may support the constant current source IB, which discharges the parasitic capacitance C_{DP} excessively charged in the data line DL and the adjacent data line ADL. The sink current control unit 840 can control driving of the dynamic current sources I_{SINK1} and I_{SINK2}.

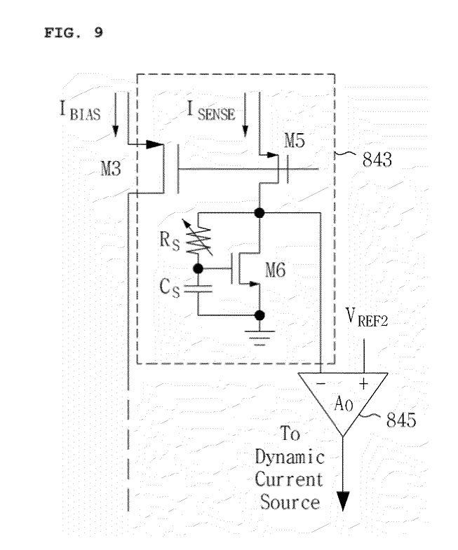

FIG. 9 is a circuit diagram illustrating the sink current control unit 840 shown in FIG. 8.

Referring to FIG. 9, the sink current control unit 840 includes a current sensor 843 and a second differential amplifier 845.

The current sensor 843 may include a first MOS transistor M5, a second MOS transistor M6, a passive resistor element R_{S}, and a capacitor C_{S}. Further, the current sensor 843 can sense an electric current I_{SENSE} having a constant ratio to a charging current I_{TC} flowing from the current mirror 810.

The first MOS transistor M5 can sense the electric current I_{SENSE} having a mirror ratio of N:1 to a MOS transistor M3.

A drain of the second MOS transistor M6 is connected to a drain of the first MOS transistor M5.

The passive resistor element R_{S} and the capacitor C_{S} are serially connected to each other between a source and a drain of the second MOS transistor M6. A connecting node between the passive resistor element R_{S} and the capacitor C_{S} is connected to a gate of the second MOS transistor M6. Since the gate of the second MOS transistor M6 is connected to the passive resistor element R_{S} and the capacitor C_{S}, when an electric current I_{SENSE} flowing through the first MOS transistor M5 is reduced, the second MOS transistor M6 is discharged through the passive resistor element R_{S}. Consequently, the second MOS transistor M6 does not enter a triode region and maintain large output impedance. The passive resistor element R_{S} may be implemented by a passive resistor or a MOS transistor.

An inverting input terminal (−) of the second differential amplifier 845 is connected to a connecting node between the first MOS transistor M5 and the second MOS transistor M6. A non-inverting input terminal (+) of the second differential amplifier 845 is connected to a second reference voltage V_{REF2}. An output terminal of the second differential amplifier 845 is connected with dynamic current sources I_{SINK1} and I_{SINK2}.

The second differential amplifier 845 compares a voltage corresponding to an electric current I_{SENSE} sensed by the current sensor 843 with a second reference voltage V_{REF2}. When the corresponding voltage is less than the second reference voltage _{VREF2}, the second differential amplifier 845 operates the dynamic current sources I_{SINK1} and I_{SINK2}. The dynamic current sources I_{SINK1} and I_{SINK2} can be implemented by MOS transistors.

Accordingly, the sink current control unit 840 senses a variation of a charging current I_{TC} from the current mirror 810. When excessively charged parasitic capacitance C_{DP} is discharged, the sink current control unit 890 operates the dynamic current sources I_{SINK1} and I_{SINK2} to support the constant current source IB and to rapidly discharge the parasitic capacitance C_{DP}.

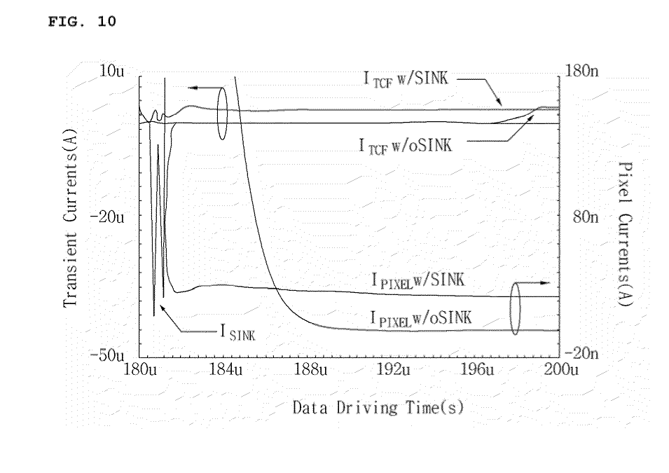

FIG. 10 is a graph illustrating a simulation result of the display driving apparatus in accordance with the second embodiment of the present invention.

First, when the dynamic current sources I_{SINK1} and I_{SINK2} are used, because an excessively charged charge is rapidly discharged by the dynamic current sources I_{SINK1} and I_{SINK2}, a data current I_{PIXEL}W/SINK less 20 nA is rapidly converged to a desired current value without a driving delay. However, when the dynamic current sources I_{SINK1} and I_{SINK2} in accordance with the present invention are not used, a very long delay occurs in the data current I_{PIXEL}W/O SINK, thereby significantly reducing driving speed.

A positive feedback loop of the display driving apparatus according to the second embodiment can be formed by a first differential amplifier 830, a MOS transistor M2 of a current output unit 820, and a current mirror 810. A negative feedback loop can be formed by the first differential amplifier 830 and the MOS transistor M2 of a current output unit 820. The fundamental operation of the display driving apparatus of the second embodiment is identical with that of the first embodiment.

### Third Embodiment

Hereinafter, a display driving apparatus in accordance with a third exemplary embodiment of the present invention will be explained with reference to the accompanying drawings.

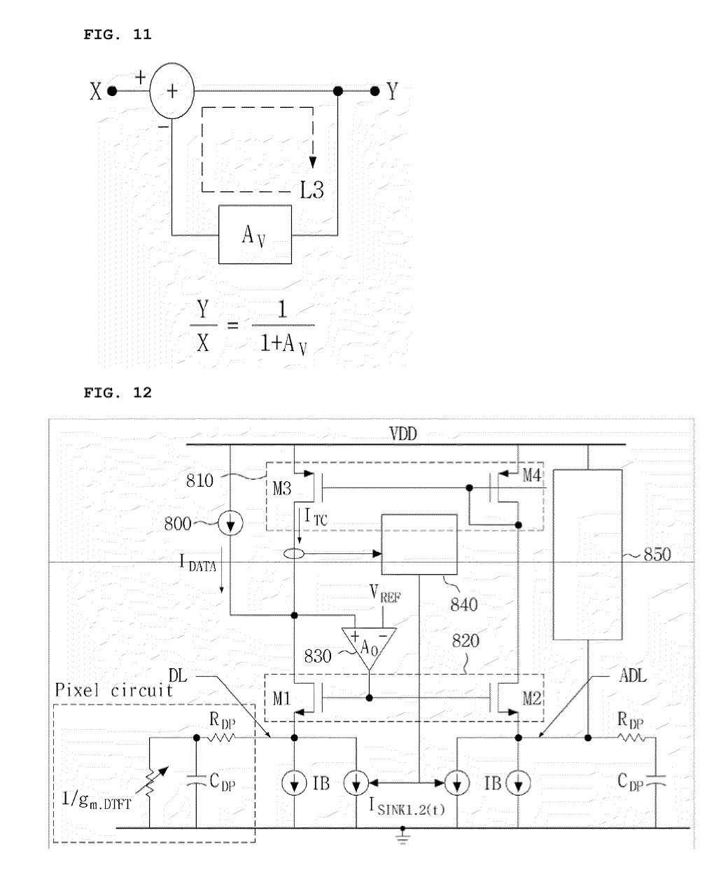

FIG. 11 is illustrates a concept of a loop gain control in accordance with an embodiment of the present invention.

In a case where a signal path is formed from a node X to a node Y, if a gain block A_{V} between the node X and the node Y forms a negative feedback loop, a gain obtained in the node Y is 1/(1+A_{V}) less than an original gain.

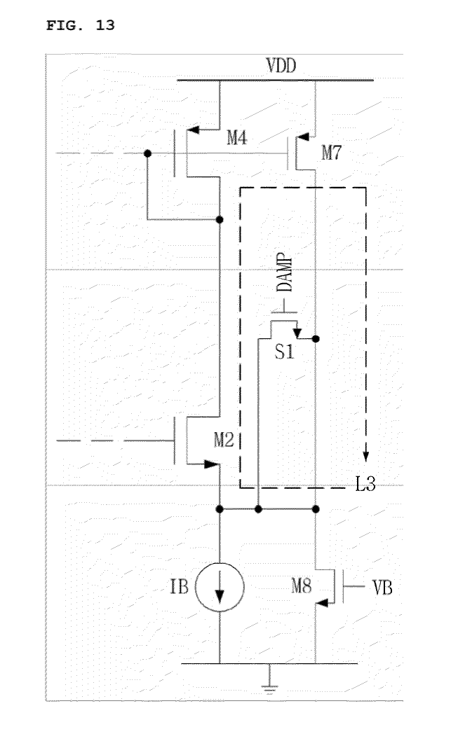

FIG. 12 and FIG. 13 are circuit diagrams illustrating display driving apparatuses in accordance with a third embodiment of the present invention to which the concept of a loop gain control is applied.

Referring to FIG. 12, the display driving apparatus in accordance with the third embodiment of the present invention includes a current DAC 800, a data line DL, an adjacent data line ADL, a current mirror 810, a current output unit 820, a first differential amplifier 830, a constant current source IB, dynamic current sources I_{SINK1} and I_{SINK2}, a sink current control unit 840, and a loop gain control unit 850.

There is a difference in construction between the display driving apparatus in accordance with the third embodiment of the present invention shown in FIG. 12 and the display driving apparatus in accordance with the second embodiment of the present invention. The difference in the construction is that a loop gain control unit 850 is added to the display driving apparatus in accordance with the third embodiment of the present invention.

Another disadvantage of the conventional display driving apparatus shown in FIG. 6 is the occurrence of under-damping when there is a data current greater than 1 μA. Under-damping is a phenomenon that an output waveform is not easily converged to a desired current value but is irregular. Here, the under-damping occurs because a positive feedback loop gain forming a driving circuit becomes stronger than a negative feedback loop gain during excessive operation. To form a negative feedback loop contacting the second driving MOS transistor M2 with a MOS transistor M4 of a current mirror 810 shown in FIG. 12, a loop gain control unit 850 is additionally provided in the third embodiment of the present invention.

FIG. 13 is a circuit diagram illustrating the loop gain control unit shown in FIG. 12.

The loop gain control unit 850 includes a third MOS transistor M7 having a predetermined mirror ratio to the MOS transistor M4 of the current mirror 810, and a fourth MOS transistor S1 connected to the third MOS transistor M7 and an adjacent data line ADL. The loop gain control unit 850 forms a negative feedback loop to weaken a loop gain of the current mirror 810, thereby removing under-damping.

In a driving method of the loop gain control unit 850, when a DAMP signal is enabled to turn-on the fourth MOS transistor S1, the transistors M2 and M3, and the third MOS transistor M7 form a negative feedback loop L3. The negative feedback loop L3 shown in FIG. 19 weakens a gain of a positive feedback loop L2 contacting with the negative feedback loop L3. A mirror ratio between the MOS transistor M4 and the third MOS transistor M7 is adjusted to increase or reduce a gain of the positive feedback loop L2, and to remove under-damping generating upon driving a data current.

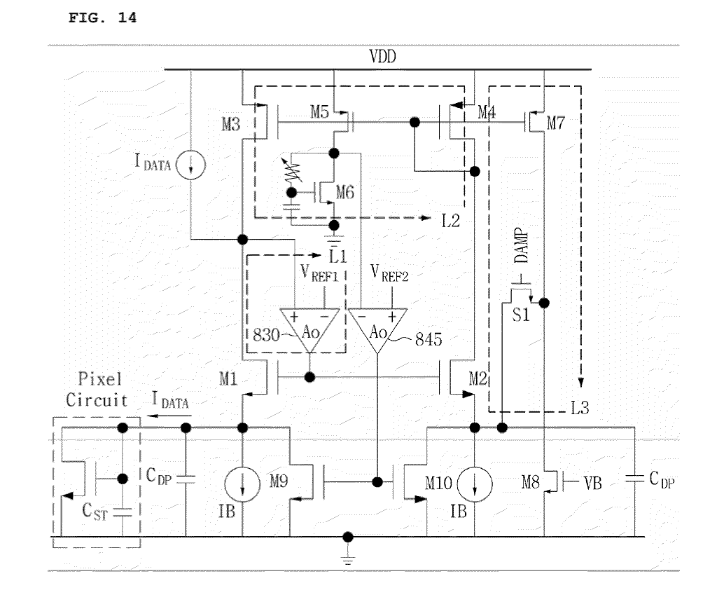

FIG. 14 is a total circuit arrangement of the display driving apparatus in accordance with a third embodiment to which the loop gain control unit of FIG. 13 is applied.

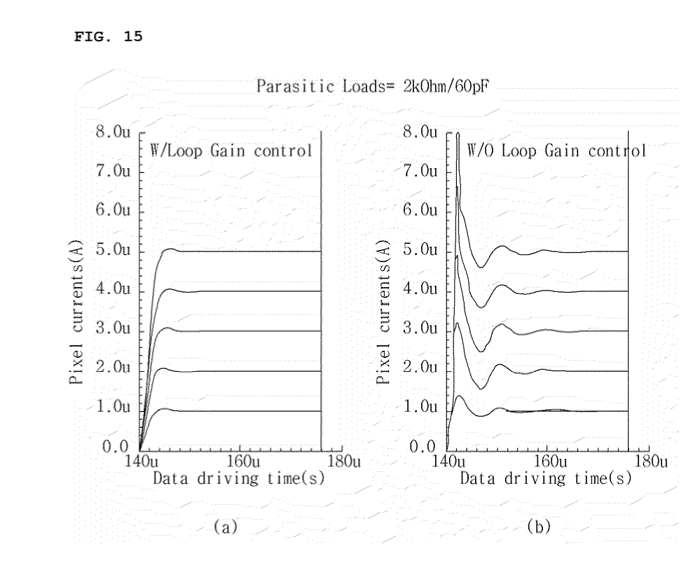

FIG. 15a is a graph illustrating a simulation result that removes under-damping occurring when driving a high data current greater than 1 uA using a loop gain control unit.

FIG. 15b is a graph illustrating a simulation result revealing severe under-damping as the data current is increased and parasitic capacitance of a panel is increased when a loop gain control unit is not used.

Although embodiments in accordance with the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A display driving apparatus comprising:
a current digital/analog converter generating a data current corresponding to an input of digital data;
a data line connected to a pixel circuit requiring data writing on a matrix array of a display panel;
an adjacent data line located adjacent to the data line;
a current mirror feedbacking an excessive charging current generating due to parasitic capacitance of the adjacent data line as a charging current for charging parasitic capacitance of the data line;
a current output unit connected to the current mirror and comprising a first driving transistor unit for driving the data line, and a second driving transistor unit for driving the adjacent data line;
a source follower driving the current output unit according to an output node voltage of the current digital/analog converter; and
a first constant current source discharging parasitic capacitance excessively charged in the data line and the adjacent data line.

2. The display driving apparatus according to claim 1, wherein the current mirror has a stack mirror structure.

3. The display driving apparatus according to claim 1, wherein the first driving MOS transistor unit comprises a plurality of cascade-connected MOS transistors,
the second driving MOS transistor unit comprises a plurality of cascade-connected MOS transistors,
the source follower comprises a third MOS transistor unit having a plurality of cascade-connected MOS transistors, and a second constant current source connected to the third MOS transistor unit,
gates of the MOS transistors of the third MOS transistor unit are connected to an output node of the current digital/analog converter, and
sources of the MOS transistors of the third MOS transistor unit are connected to gates of MOS transistors of the first driving MOS transistor unit and the second driving MOS transistor unit.

4. A display driving apparatus comprising:
a current digital/analog converter generating a data current corresponding to an input of digital data;
a data line connected to a pixel circuit requiring data writing on a matrix array of a display panel;
an adjacent data line located adjacent to the data line;
a current mirror feedbacking an excessive charging current generating due to parasitic capacitance of the adjacent data line as a charging current for charging parasitic capacitance of the data line;
a current output unit connected to the current mirror and including a first driving MOS transistor for driving the data line, and a second driving MOS transistor for driving the adjacent data line;
a first differential amplifier including a non-inverting input terminal connected to an output node of the current digital/analog converter, an inverting input terminal connected to a first reference voltage, and an output terminal connected to gates of the first driving MOS transistor and the second driving MOS transistor;
a constant current source for discharging parasitic capacitance excessively charged in the data line and the adjacent data line;
a dynamic current source for supporting the constant current source; and
a sink current control unit comprising a current sensor sensing an electric current having a constant ratio to a charging current flowing from the current mirror, and a second differential amplifier comparing a voltage corresponding to the electric current sensed by the current sensor with a second reference voltage, and operating the dynamic current control unit when the corresponding voltage is less than the second reference voltage.

5. The display driving apparatus according to claim 4, wherein the dynamic current source includes a MOS transistor.

6. The display driving apparatus according to claim 4, wherein the current sensor comprises:
a first MOS transistor having a predetermined mirror ratio to the current mirror and including a source receiving an electric current with a predetermined ratio to the charging current;
a second MOS transistor including a drain connected to a drain of the first MOS transistor;
a passive resistor element and a capacitor serially connected to each other between a source and a drain of the second MOS transistor,
wherein a connecting node between the passive resistor element and the capacitor is connected to a gate of the second MOS transistor, and
the second differential amplifier includes an inverting input terminal connected to a connecting node between the first MOS transistor and the second MOS transistor, and a non-inverting input terminal connected to a second reference voltage, and an output terminal connected with the dynamic current source.

7. A display driving apparatus comprising:
a current digital/analog converter generating a data current corresponding to an input of digital data;
a data line located connected to a pixel circuit requiring data writing on a matrix array of a display panel;
an adjacent data line located adjacent to the data line;
a current mirror feedbacking an excessive charging current generating due to parasitic capacitance of the adjacent data line as a charging current for charging parasitic capacitance of the data line;
a current output unit connected to the current mirror and including a first driving MOS transistor for driving the data line, and a second driving MOS transistor for driving the adjacent data line;
a first differential amplifier including a non-inverting input terminal connected to an output node of the current digital/analog converter, an inverting input terminal connected to a first reference voltage, and an output terminal connected to gates of the first driving MOS transistor and the second driving MOS transistor;
a constant current source for discharging parasitic capacitance excessively charged in the data line and the adjacent data line;
a dynamic current source for supporting the constant current source;
a sink current control unit comprising a current sensor sensing an electric current having a constant ratio to a charging current flowing from the current mirror, and a second differential amplifier comparing a voltage corresponding to the electric current sensed by the current sensor with a second reference voltage, and operating the dynamic current control unit when the corresponding voltage is less than the second reference voltage; and
a loop gain control unit forming a negative feedback loop to weaken a loop gain of the current mirror.

8. The display driving apparatus according to claim 7, wherein the dynamic current source comprises a MOS transistor.

9. The display driving apparatus according to claim 7, wherein the current sensor comprises:
a first MOS transistor having a predetermined mirror ratio to the current mirror and including a source receiving an electric current with a predetermined ratio to the charging current;
a second MOS transistor including a drain connected to a drain of the first MOS transistor;
a passive resistor element and a capacitor serially connected to each other between a source and a drain of the second MOS transistor,
wherein a connecting node between the passive resistor element and the capacitor is connected to a gate of the second MOS transistor, and
the second differential amplifier includes an inverting input terminal connected to a connecting node between the first MOS transistor and the second MOS transistor, and a non-inverting input terminal connected to a second reference voltage, and an output terminal connected with the dynamic current source.

10. The display driving apparatus according to claim 7, wherein the loop gain control unit comprises a third MOS transistor having a predetermined mirror ratio to the current mirror, and a fourth MOS transistor connected to the third MOS transistor and the adjacent data line, the negative feedback loop being formed when the fourth MOS transistor is turned-on.
